(19) United States
(12) Patent Application Publication
(10) Pub. No.: US 2023/0192521 A1
(43) Pub. Date: Jun. 22, 2023

(54) Metal Surface Treatment Liquid Recycling System and Operation Method Thereof

(71) Applicants: Chung-Heng Liao, Taipei City (TW); Pei-Juo Liao, Taipei City (TW)

(72) Inventors: Chung-Heng Liao, Taipei City (TW); Pei-Juo Liao, Taipei City (TW)

(21) Appl. No.: 17/724,637

(22) Filed: Apr. 20, 2022

(30) Foreign Application Priority Data
Dec. 20, 2021 (CN) 202111560543.5

(51) Int. Cl. C02F 9/00; B01D 61/02; B01D 3/10; B01D 5/00; B01D 1/00

(52) U.S. Cl. CPC C02F 9/00; B01D 61/027; B01D 61/022; B01D 3/106; B01D 5/006; B01D 1/0047; B01D 2313/243; B01D 2311/14; B01D 2311/2669; B01D 2311/25; C02F 1/043

(57) ABSTRACT

A metal surface treatment liquid recycling system includes a treatment liquid collecting tank, a pre-treatment device, a nanofiltration device and a vacuum distillation device, all of which are connected sequentially. The nanofiltration device includes a feed tank, a first-stage nanofiltration membrane unit, and a second-stage nanofiltration membrane unit. Treatment wastewater in the treatment liquid collecting tank is fed into the pre-treatment device to filter out suspended solids and then enter the feed tank. The wastewater in the feed tank is filtered by the first-stage nanofiltration membrane unit and transformed to a first-stage concentrated waste liquid and first-stage infiltration fluids. The first-stage infiltration fluids are fed into and re-filtered by the second-stage nanofiltration membrane unit and transformed to a second-stage concentrated waste liquid and second-stage infiltration fluids. The second-stage infiltration fluids are evaporated and concentrated by the vacuum distillation device for generation of distilled water and high-concentration acid concentrated fluids.

### BACKGROUND OF THE INVENTION

### 1. Field of the Invention

The present invention relates to treatment of wastewater and, more particularly, to a metal surface treatment liquid recycling system and an operation method thereof.

### 2. Description of the Related Art

There are a variety of strong acids (for example, phosphoric acid, sulfuric acid and nitric acid) applicable to the technical processes for metal surface treatment during which a metal surface is acid-cleaned, etched or polished. When metal surface treatment falls short of the technical demand due to a concentration of metal ions inside acid liquids approaching a certain level, acid liquids should be prepared once again and replaced. In this metal surface treatment process, a large amount of acid wastewater is generated and two issues are derived: (1) Cost rises because high-concentration acid wastewater is neutralized by plenty of alkali liquids or outsourced to an eligible business operator for acid treatment; (2) Lots of valuable acids such as phosphoric acid are wasted.

Accordingly, it is necessary to invent a new technical technology and process for treatment of wastewater through which the drawbacks mentioned above are overcome.

### BRIEF SUMMARY OF THE INVENTION

Thus, an objective of the present invention is to provide a metal surface treatment liquid recycling system in which a nanofiltration device and a vacuum distillation device are integrated. The nanofiltration device is used in separating metal ions and acid liquids first, and separated acid-containing infiltration fluids are concentrated in the vacuum distillation device and transformed to concentrated fluids with high concentrations of acids for recycling and maximization of resource utilization.

To achieve this and other objectives, a metal surface treatment liquid recycling system of the present invention includes a treatment liquid collecting tank, a pre-treatment device, a nanofiltration device, a vacuum distillation device and a concentrated fluid recycling tank, all of which are connected sequentially. The nanofiltration device includes a feed tank, a first-stage nanofiltration membrane unit and a second-stage nanofiltration membrane unit. The treatment liquid collecting tank accommodates treatment wastewater to be fed into the pre-treatment device in which suspended solids are screened out for delivery of the wastewater into the feed tank. The wastewater in the feed tank is delivered into and filtered by the first-stage nanofiltration membrane unit and transformed to a first-stage concentrated waste liquid and first-stage infiltration fluids. The first-stage infiltration fluids are fed into and re-filtered by the second-stage nanofiltration membrane unit and transformed to a second-stage concentrated waste liquid and second-stage infiltration fluids. The first-stage and second-stage concentrated waste liquids with high-concentration metal ions are delivered into a wastewater pond for treatment, and the second-stage infiltration fluids are delivered into the vacuum distillation device in which the second-stage infiltration fluids are further evaporated and concentrated for generation of distilled water and concentrated fluids with high concentrations of acids. The concentrated fluids are fed into the concentrated fluid recycling tank for follow-up recycling, and the distilled water are delivered into a water reservoir for follow-up recycling.

In a preferred form, the wastewater in the feed tank is pumped into the first-stage nanofiltration membrane unit through a first-stage high-pressure pump and a first-stage feed tube. The first-stage infiltration fluids are discharged from a first-stage infiltration fluid discharging tube and then pumped into the second-stage nanofiltration membrane unit through a second-stage high-pressure pump as well as a second-stage feed tube. The first-stage concentrated waste liquid is discharged from a first-stage concentrated waste liquid discharging tube on which a first-stage pressure gage and a first-stage pressure regulating valve are installed. The second-stage concentrated waste liquid is discharged from a second-stage concentrated waste liquid discharging tube on which a second-stage pressure gage and a second-stage pressure regulating valve are installed. The second-stage infiltration fluid is discharged to the vacuum distillation device through a second-stage infiltration fluid discharging tube.

In a preferred form, the first-stage nanofiltration membrane unit and the second-stage nanofiltration membrane unit are equipped with high pressure-resistant and concentrated acid-resistant nanofiltration membranes with which bivalent and multivalent metal ions can be captured.

In a preferred form, the filtering media inside the pre-treatment device is selected from at least one of silica sand, activated carbon and anthracite, and the pre-treatment device is used in screening out suspended solids with grain sizes larger than 1 μm in the treatment wastewater.

In a preferred form, the vacuum distillation device includes an evaporator, a condenser, and a buffer tank. The evaporator and a vacuum pump are connected with each other. The evaporator is provided with a heating pipe therein and a heating jacket on a bottom thereof. A wastewater inlet, a concentrated fluid outlet, a steam inlet, a steam water outlet and a water vapor outlet are arranged outside the evaporator. A water vapor inlet, a distilled water outlet, a cooling water inlet and a cooling water outlet are provided outside the condenser. The second-stage infiltration fluids are delivered into the evaporator through the wastewater inlet. Heating steam enters the heating pipe and the heating jacket through the steam inlet to heat the external waste liquids, and the heat-exchanged steam is transformed to water that is discharged from the evaporator through the steam water outlet. Heated water vapor in the wastewater is delivered into the condenser through the water vapor outlet, and the concentrated fluids are discharged into the concentrated fluid recycling tank through the concentrated fluid outlet. The water vapor cooled down by cooling water inside the condenser is discharged to the buffer tank through the distilled water outlet to form the distilled water, and the distilled water stabilized in the buffer tank is pumped out by a draining pump for recycling.

The present invention also provides an operation method of the metal surface treatment liquid recycling system, comprising steps as follows:

Step 1: Used metal surface treatment liquids are delivered into the treatment liquid collecting tank, the acid wastewater with high-concentration metal ions inside the treatment liquid collecting tank is fed into the pre-treatment device through a pipeline to filter out suspended solids with grain sizes greater than 1 μm, and the acid wastewater is discharged to the feed tank of the nanofiltration device.

Step 2: The wastewater in the feed tank is pumped into the first-stage nanofiltration membrane unit by the first-stage high-pressure pump to form a first-stage concentrated waste liquid and first-stage infiltration fluids, the first-stage pressure regulating valve is activated to regulate an osmotic pressure of the first-stage nanofiltration membrane unit within a range from 4.5 Mpa to 5.5 Mpa between which bivalent and multivalent metal ions are captured in the first-stage concentrated waste liquid by the first-stage nanofiltration membrane unit, and the first-stage infiltration fluids passing through the first-stage nanofiltration membrane unit are discharged to the second-stage nanofiltration membrane unit.

Step 3: The first-stage infiltration fluids are pumped into the second-stage nanofiltration membrane unit by the second-stage high-pressure pump to form a second-stage concentrated waste liquid and second-stage infiltration fluids, the second-stage pressure regulating valve is activated to regulate an osmotic pressure of the second-stage nanofiltration membrane unit within a range from 5.0 Mpa to 6.0 Mpa between which bivalent and multivalent metal ions are captured in the second-stage concentrated waste liquid by the second-stage nanofiltration membrane unit, and the second-stage infiltration fluids passing through the second-stage nanofiltration membrane unit are discharged to the vacuum distillation device.

Step 4: The second-stage infiltration fluids with a trace of metal ions are further evaporated and concentrated in the vacuum distillation device in which a vacuum degree is kept at a range from 80 Kpa to 90 Kpa for evaporation and separation of moistures in second-stage infiltration fluids at temperature between 40° C. and 50° C. for generation of distilled water and acid concentrated fluids. When the acid concentration in the wastewater rises to a preset concentration, the vacuum distillation device stops running, and the concentrated fluids with a trace of metal ions and high-concentration acids are discharged from the evaporator and collected in the concentrated fluid recycling tank for reuses and the distilled water is recycled as industrial water.

The metal surface treatment liquid recycling system of the present invention has the following beneficial effects:

1. The metal surface treatment liquid recycling system includes the pre-treatment device, the nanofiltration device and the vacuum distillation device. The acid wastewater rich in metal ions is fed into the pre-treatment device in which suspended solids with grain sizes greater than 1 μm are screened out first, and is further transmitted to the nanofiltration device which relies on the separation technique of a nanofiltration membrane to capture bivalent and multivalent metal ions in acid wastewater effectively. The acid wastewater from which impurities are removed is evaporated and concentrated by the vacuum distillation device and directly recycled in the case of a concentration of acids over 85%. Accordingly, both impurities and metal ions in acid wastewater are separated by the metal surface treatment liquid recycling system effectively and the acid wastewater are evaporated and concentrated for impurity-free acid liquids concentrated and recycled and maximization of resource utilization.

2. The nanofiltration device adopted in the metal surface treatment liquid recycling system depends on the separation technique of a nanofiltration membrane to separate and clean impurities in acid wastewater and particularly capture metal ions. Based on the principle of absorption and diffusion, the nanofiltration membrane is a new separation membrane invented in 1980s between the ultra-filtration membrane and the reverse osmosis membrane and working by means of a pressure difference as a driving force as well as a pressurized-membrane separation technique, that is, a specific thin membrane on which some apertures are opened allows both micromolecule solutes and solvents to pass through under a certain pressure but keeps macromolecule solutes left behind. In addition to macromolecule solutes captured by the nanofiltration membranes of the present invention, most bivalent and multivalent metal ions are also captured by the nanofiltration membranes. Moreover, the nanofiltration device of the present invention includes two-stage nanofiltration membranes with two single nanofiltration membrane units arranged as a cascaded connection. The capture rate of the first-stage nanofiltration membrane unit for metal ions is 75%˜80%, and the capture rate of the second-stage nanofiltration membrane unit is 85%˜90%. Accordingly, with bivalent and multivalent metal ions separated from acids by the two-stage cascaded nanofiltration membrane units, the level of metal ions inside concentrated acid liquids meet the criteria of treatment liquids for direct recycling of acid liquids.

3. The vacuum distillation device adopted in the metal surface treatment liquid recycling system is designed for a continuous distillation process under a high-vacuum condition (−80 Kpa˜−90 Kpa) through which moistures in the acid wastewater are evaporated and separated at low temperature (40° C.˜50° C.) for higher acidity and acid liquids are not damaged under transient heating and operating temperatures far lower than a substance's boiling point at normal pressure for recycling of acid liquids.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 is a flowchart for a technical process of a metal surface treatment liquid recycling system of the present invention.

FIG. 2 is a structural schematic view of a nanofiltration device in the metal surface treatment liquid recycling system of the present invention.

FIG. 3 is a structural schematic view of a vacuum distillation device in the metal surface treatment liquid recycling system of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood.

Where used in the various figures of the drawings, the same numerals designate the same or similar parts. Furthermore, when the terms ‘first-stage’, “second-stage”, “inside”, “outside”, “bottom”, “external” and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

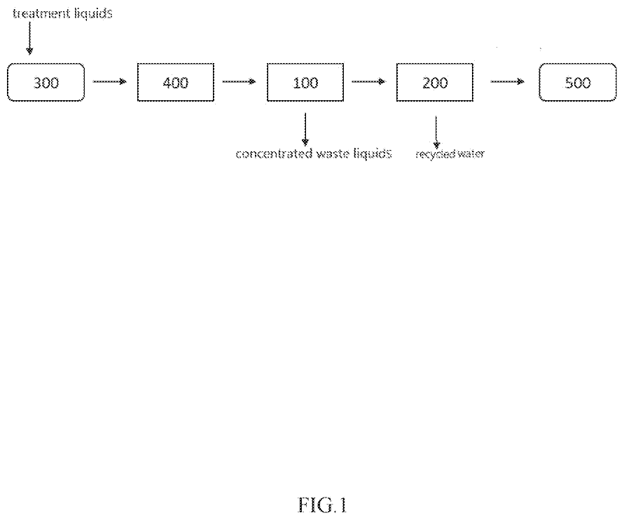

A metal surface treatment liquid recycling system according to an embodiment of the present invention is shown in FIGS. 1 through 3 of the drawings and includes a treatment liquid collecting tank 300, a pre-treatment device 400, a nanofiltration device 100, a vacuum distillation device 200 and a concentrated fluid recycling tank 500, all of which are connected sequentially. The nanofiltration device 100 includes a feed tank 110, a first-stage nanofiltration membrane unit 120 and a second-stage nanofiltration membrane unit 130. The treatment liquid collecting tank 300 accommodates treatment liquids (acid wastewater) to be fed into the pre-treatment device 400 in which suspended solids are screened out for delivery of acid wastewater into the feed tank 110. The wastewater in the feed tank 110 is fed into the first-stage nanofiltration membrane unit 120 in which wastewater is filtered and transformed to a first-stage concentrated waste liquid and first-stage infiltration fluids. The first-stage infiltration fluids are fed into the second-stage nanofiltration membrane unit 130 for further screening and transformed to a second-stage concentrated waste liquid and second-stage infiltration fluids. The first-stage and second-stage concentrated waste liquids with high-concentration metal ions are fed into a wastewater pond for treatment, and the second-stage infiltration fluids are delivered into the vacuum distillation device 200 in which the second-stage infiltration fluids are further evaporated and concentrated for generation of distilled water and concentrated fluids with high concentrations of acids. The concentrated fluids are fed into the concentrated fluid recycling tank 500 for follow-up recycling, and the distilled water are delivered into a water reservoir for follow-up recycling. The metal surface treatment liquid recycling system of the present invention is used in recycling acid-containing metal surface treatment liquids rich of metal ions. Comparatively, the traditional recycling system, only the acid and water in the waste liquids are separated, and the metal ions in the acid liquid cannot be separated. If the concentration of metal ions in the acid liquids is higher than a certain level, the acid liquids cannot be used. For example, the concentrated acid liquids using the traditional recovery system still contain high concentrations of metal ions, so it cannot be used directly. In other words, the traditional recycling system falls short of the standard for treatment of high-concentration metal ions inside concentrated acid liquids.

With acids and metal ions screened out by the nanofiltration device 100 of the present invention first, the acids in wastewater are concentrated in the vacuum distillation device 200, and the obtained concentrated fluids can be directly used in technical processes of metal surface treatment, for example, acid cleaning, etching, polishing, etc. Accordingly, the nanofiltration device and the vacuum distillation device are integrated into the metal surface treatment liquid recycling system of the present invention. In the system, both metal ions and acid liquids are first separated in the nanofiltration device. Except a small quantity of waste liquid with high-concentration metal ions (that is, some fluids trapped by the nanofiltration device) for further treatment, the water and concentrated fluids obtained by the infiltration fluids from the nanofiltration device through the vacuum distillation device can be recycled for maximization of resource utilization.

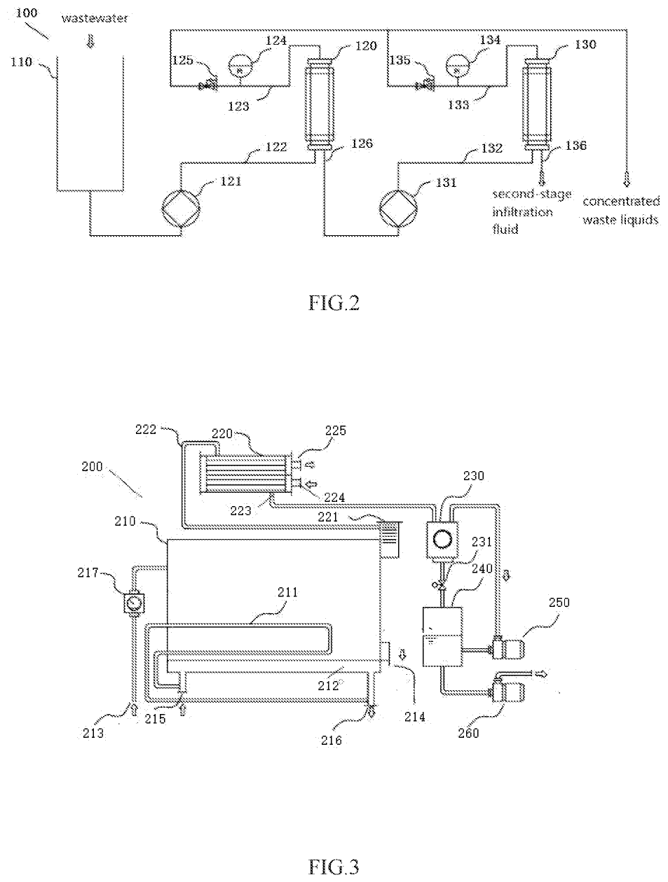

As shown in FIG. 2, wastewater in the feed tank 110 is pumped into the first-stage nanofiltration membrane unit 120 through a first-stage high-pressure pump 121 and a first-stage feed tube 122. The first-stage infiltration fluids are discharged from a first-stage infiltration fluid discharging tube 126 and then pumped into the second-stage nanofiltration membrane unit 130 through a second-stage high-pressure pump 131 as well as a second-stage feed tube 132. On the other hand, the first-stage concentrated waste liquid is discharged from a first-stage concentrated waste liquid discharging tube 123 on which a first-stage pressure gage 124 as well as a first-stage pressure regulating valve 125 are installed. The second-stage concentrated waste liquid is discharged from a second-stage concentrated waste liquid discharging tube 133 on which a second-stage pressure gage 134 as well as a second-stage pressure regulating valve 135 are installed. The second-stage infiltration fluid is discharged to the vacuum distillation device 200 through a second-stage infiltration fluid discharging tube 136. The pressure gages are used in indicating pressures. The first-stage pressure regulating valve 125 is used in controlling a ratio of infiltration fluids to highly-concentrated waste liquid from the first-stage nanofiltration membrane unit 120. Similarly, the second-stage pressure regulating valve 135 is used in controlling a ratio of infiltration fluids to highly-concentrated waste liquid from the second-stage nanofiltration membrane unit 130. Based on the principle of absorption and diffusion, the nanofiltration membrane is a new separation membrane invented in 1980s between the ultra-filtration membrane and the reverse osmosis membrane and working by means of a pressure difference as a driving force as well as a pressurized-membrane separation technique, that is, a specific thin membrane on which some apertures are opened allows both micromolecule solutes and solvents to pass through under a certain pressure but keeps macromolecule solutes left behind. In practice, more bivalent and multivalent metal ions are captured by a nanofiltration membrane than others. In the metal surface treatment liquid recycling system, the nanofiltration device 100 includes two-stage nanofiltration membranes with two single nanofiltration membrane units arranged as a cascade connection. The capture rate of the first-stage nanofiltration membrane unit 120 for metal ions is 75%˜80%, and the capture rate of the second-stage nanofiltration membrane unit 130 is 85%˜90%. Accordingly, most metal ions are trapped in a small amount of first-stage and second-stage concentrated waste liquids, and trace amounts of metal ions in infiltration fluids can meet the needs of polishing liquid and other applications.

The first-stage nanofiltration membrane unit 120 and the second-stage nanofiltration membrane unit 130 are equipped with high pressure-resistant and concentrated acid-resistant nanofiltration membranes with which bivalent and multivalent metal ions are captured. In addition to macromolecule solutes captured by the nanofiltration membrane, most bivalent and multivalent metal ions are also captured by the nanofiltration membrane and separated from acids such that the level of metal ions in concentrated acid fluids meets the criteria of treatment liquids for direct recycling of acid liquids.

The filtering media inside the pre-treatment device 400 is selected from at least one of silica sand, activated carbon and anthracite, and the pre-treatment device 400 is used in screening out suspended solids with grain sizes larger than 1 μm in treatment liquids.

As shown in FIG. 3, the vacuum distillation device 200 includes an evaporator 210, a condenser 220, and a buffer tank 240. The evaporator 210 and a vacuum pump 250 are connected with each other. The evaporator 210 is provided with a heating pipe 211 therein and a heating jacket 212 on a bottom thereof. A wastewater inlet 213, a concentrated fluid outlet 214, a steam inlet 215, a steam water outlet 216 and a water vapor outlet (not shown) are arranged outside the evaporator 210. A water vapor inlet 222, a distilled water outlet 223, a cooling water inlet 224 and a cooling water outlet 225 are provided outside the condenser 220. The second-stage infiltration fluids are delivered into the evaporator 210 through the wastewater inlet 213. The heating steam enters the heating pipe 211 and the heating jacket 212 through the steam inlet 215 to heat the external wastewater (the second-stage infiltration fluids). The steam from which heat is exchanged is transformed to water that is discharged from the evaporator 210 through the steam water outlet 216. The heated water vapor in the wastewater is delivered into the condenser 220 through the water vapor outlet, and the concentrated fluids are discharged into the concentrated fluid recycling tank 500 through the concentrated fluid outlet 214. The water vapor cooled down by cooling water inside the condenser 220 is discharged to the buffer tank 240 through the distilled water outlet 223 to form the distilled water. The distilled water stabilized in the buffer tank 240 is pumped out by a draining pump 260 for recycling. A screening program 221 is installed on the pipeline between the water vapor outlet of the evaporator 210 and the water vapor inlet 222 of the condenser 220 and used in screening out impurities inside the water vapor. A gauge 217 is installed on the wastewater inlet 213 of the evaporator 210 and used in recording water flows delivered into the evaporator 210. A gauge tank 230 is installed between the condenser 220 and the buffer tank 240, and an automatic valve 231 is installed between the gauge tank 230 and the buffer tank 240. The vacuum distillation device 200 is designed for a continuous distillation process under a high-vacuum condition (−80 Kpa˜−90 Kpa) through which moistures in acid liquids are evaporated and separated at low temperature (40° C. 50° C.) for higher acidity and acid liquids are not damaged under transient heating and operating temperatures far lower than a substance's boiling point at normal pressure.

The operation method of the metal surface treatment liquid recycling system of the present invention includes steps as follows:

Step 1: Used metal surface treatment liquids (acid wastewater) are delivered into the treatment liquid collecting tank 300. Acid wastewater with high-concentration metal ions inside the treatment liquid collecting tank 300 is fed into the pre-treatment device 400 through a pipeline to filter out suspended solids with grain sizes greater than 1 μm, and then enters the feed tank 110 of the nanofiltration device 100.

Step 2: Wastewater in the feed tank 110 is pumped into the first-stage nanofiltration membrane unit 120 by the first-stage high-pressure pump 121. The first-stage pressure regulating valve 125 is activated to regulate an osmotic pressure of the first-stage nanofiltration membrane unit 120 within a range from 4.5 Mpa to 5.5 Mpa between which bivalent and multivalent metal ions are captured in the first-stage concentrated waste liquid by the first-stage nanofiltration membrane unit 120, and the first-stage infiltration fluids passing through the first-stage nanofiltration membrane unit 120 are discharged to the second-stage nanofiltration membrane unit 130.

Step 3: The first-stage infiltration fluids are pumped into the second-stage nanofiltration membrane unit 130 by the second-stage high-pressure pump 131. The second-stage pressure regulating valve 135 is activated to regulate an osmotic pressure of the second-stage nanofiltration membrane unit 130 within a range from 5.0 Mpa to 6.0 Mpa between which bivalent and multivalent metal ions are captured in the second-stage concentrated waste liquid by the second-stage nanofiltration membrane unit 130, and the second-stage infiltration fluids are discharged to the vacuum distillation device 200 through the second-stage nanofiltration membrane unit 130.

Step 4: The second-stage infiltration fluids with a trace of metal ions are further evaporated and concentrated in the vacuum distillation device 200 in which a vacuum degree is kept at a range from 80 Kpa to 90 Kpa for evaporation and separation of moistures in the second-stage infiltration fluids at temperature between 40° C. and 50° C. The vacuum distillation device 200 will be shut down in the case of a concentration of acids inside wastewater rising and approximating a default concentration. The concentrated fluid containing trace metal ions and high-concentration acid is discharged from the evaporator 210 and collected in the concentrated fluid recycling tank 500 for reuses, and the evaporated water is recycled as industrial water. The quality percentage of the finally obtained concentrated fluid acid can reach more than 85%, and the content of metal ions such as aluminum ions is extremely low, which meets the use requirements of metal surface treatment agents. In the present invention, 85-90% of the metal ions can be screened out by the two-stage series connected nanofiltration membrane units, and the acid concentration can be increased to more than 85% by the vacuum distillation device 200 to meet the demand for usage, and recycling of water is satisfactory.

The scope of the invention is to be indicated by the appended claims, rather than by the foregoing description, and all changes which come within the meaning and range of equivalency of the claims are intended to be embraced therein.

1. A metal surface treatment liquid recycling system comprising a treatment liquid collecting tank (300), a pre-treatment device (400), a nanofiltration device (100), a vacuum distillation device (200) and a concentrated fluid recycling tank (500), all of which are connected sequentially, wherein the nanofiltration device (100) includes a feed tank (110), a first-stage nanofiltration membrane unit (120) and a second-stage nanofiltration membrane unit (130), wherein the treatment liquid collecting tank (300) accommodates treatment wastewater to be fed into the pre-treatment device (400) in which suspended solids are screened out for delivery of the wastewater into the feed tank (110), wherein the wastewater in the feed tank (110) is delivered into and filtered by the first-stage nanofiltration membrane unit (120) and transformed to a first-stage concentrated waste liquid and first-stage infiltration fluids, wherein the first-stage infiltration fluids are fed into and re-filtered by the second-stage nanofiltration membrane unit (130) and transformed to a second-stage concentrated waste liquid and second-stage infiltration fluids, wherein the first-stage and second-stage concentrated waste liquids with high-concentration metal ions are delivered into a wastewater pond for treatment, and the second-stage infiltration fluids are delivered into the vacuum distillation device (200) in which the second-stage infiltration fluids are further evaporated and concentrated for generation of distilled water and concentrated fluids with high concentrations of acids, wherein the concentrated fluids are fed into the concentrated fluid recycling tank (500) for follow-up recycling, and the distilled water are delivered into a water reservoir for follow-up recycling.

2. The metal surface treatment liquid recycling system according to claim 1, wherein the wastewater in the feed tank (110) is pumped into the first-stage nanofiltration membrane unit (120) through a first-stage high-pressure pump (121) and a first-stage feed tube (122), wherein the first-stage infiltration fluids are discharged from a first-stage infiltration fluid discharging tube (126) and then pumped into the second-stage nanofiltration membrane unit (130) through a second-stage high-pressure pump (131) as well as a second-stage feed tube (132), wherein the first-stage concentrated waste liquid is discharged from a first-stage concentrated waste liquid discharging tube (123) on which a first-stage pressure gage (124) and a first-stage pressure regulating valve (125) are installed, wherein the second-stage concentrated waste liquid is discharged from a second-stage concentrated waste liquid discharging tube (133) on which a second-stage pressure gage (134) and a second-stage pressure regulating valve (135) are installed, wherein the second-stage infiltration fluid is discharged to the vacuum distillation device (200) through a second-stage infiltration fluid discharging tube (136).

3. The metal surface treatment liquid recycling system according to claim 1, wherein the first-stage nanofiltration membrane unit (120) and the second-stage nanofiltration membrane unit (130) are equipped with high pressure-resistant and concentrated acid-resistant nanofiltration membranes with which bivalent and multivalent metal ions can be captured.

4. The metal surface treatment liquid recycling system according to claim 1, wherein the pre-treatment device (400) accommodates a filtering media which is selected from at least one of silica sand, activated carbon and anthracite, and the pre-treatment device (400) is used in screening out suspended solids with grain sizes larger than 1 μm in the treatment wastewater.

5. The metal surface treatment liquid recycling system according to claim 1, wherein the vacuum distillation device (200) includes an evaporator (210), a condenser (220), and a buffer tank (240), with the evaporator (210) and a vacuum pump (250) connected with each other, wherein the evaporator (210) is provided with a heating pipe (211) therein and a heating jacket (212) on a bottom thereof, wherein a wastewater inlet (213), a concentrated fluid outlet (214), a steam inlet (215), a steam water outlet (216) and a water vapor outlet are arranged outside the evaporator (210), wherein a water vapor inlet (222), a distilled water outlet (223), a cooling water inlet (224) and a cooling water outlet (225) are provided outside the condenser (220), wherein the second-stage infiltration fluids are delivered into the evaporator (210) through the wastewater inlet (213), wherein heating steam enters the heating pipe (211) and the heating jacket (212) through the steam inlet (215) to heat the external wastewater, wherein the heat-exchanged steam is transformed to water that is discharged from the evaporator (210) through the steam water outlet (216), wherein heated water vapor in the wastewater is delivered into the condenser (220) through the water vapor outlet, and the concentrated fluids are discharged into the concentrated fluid recycling tank (500) through the concentrated fluid outlet (214), wherein the water vapor cooled down by cooling water inside the condenser (220) is discharged to the buffer tank (240) through the distilled water outlet (223) to form the distilled water, and the distilled water stabilized in the buffer tank (240) is pumped out by a draining pump (260) for recycling.

6. An operation method of a metal surface treatment liquid recycling system, the metal surface treatment liquid recycling system comprising a treatment liquid collecting tank (300), a pre-treatment device (400), a nanofiltration device (100), a vacuum distillation device (200) and a concentrated fluid recycling tank (500) connected in sequence, wherein the nanofiltration device (100) includes a feed tank (110), a first-stage nanofiltration membrane unit (120) and a second-stage nanofiltration membrane unit (130), wherein the vacuum distillation device (200) includes an evaporator (210), wherein the operation method comprises:
delivering used metal surface treatment acid wastewater into the treatment liquid collecting tank (300), feeding the wastewater with high-concentration metal ions in the treatment liquid collecting tank (300) through a pipeline into the pre-treatment device (400) in which suspended solids with grain sizes greater than 1 μm are screened out, and then discharging the wastewater into the feed tank (110) of the nanofiltration device (100);
pumping the wastewater in the feed tank (110) into the first-stage nanofiltration membrane unit (120) by a first-stage high-pressure pump (121) to form a first-stage concentrated waste liquid and first-stage infiltration fluids, activating a first-stage pressure regulating valve (125) to regulate an osmotic pressure of the first-stage nanofiltration membrane unit (120) within a range from 4.5 Mpa to 5.5 Mpa between which bivalent and multivalent metal ions are captured in the first-stage concentrated waste liquid by the first-stage nanofiltration membrane unit (120), and then discharging the first-stage infiltration fluids which pass through the first-stage nanofiltration membrane unit (120) into the second-stage nanofiltration membrane unit (130);
pumping the first-stage infiltration fluids into the second-stage nanofiltration membrane unit (130) by a second-stage high-pressure pump (131) to form a second-stage concentrated waste liquid and second-stage infiltration fluids, activating a second-stage pressure regulating valve (135) to regulate an osmotic pressure of the second-stage nanofiltration membrane unit (130) within a range from 5.0 Mpa to 6.0 Mpa between which bivalent and multivalent metal ions are captured in second-stage concentrated waste liquid by the second-stage nanofiltration membrane unit (130), and then discharging the second-stage infiltration fluids which pass through the second-stage nanofiltration membrane unit (130) into the vacuum distillation device (200); and further evaporating and concentrating the second-stage infiltration fluids with a trace of metal ions in the vacuum distillation device (200) in which a vacuum degree is kept at a range from 80 Kpa to 90 Kpa for evaporation and separation of moistures in the second-stage infiltration fluids at temperature between 40° C. and 50° C. for generation of distilled water and acid concentrated fluids, wherein the vacuum distillation device (200) will be shut down in the case of a concentration of acids inside the wastewater rising to a preset concentration, and the concentrated fluids with a trace of metal ions and high-concentration acids are discharged from the evaporator (210) and collected in the concentrated fluid recycling tank (500) for reuses and the distilled water is recycled as industrial water.
